(19) United States
(12) Patent Application Publication
(10) Pub. No.: US 2012/0169447 A1
(43) Pub. Date: Jul. 5, 2012

(54) NANOCOMPOSITE POWDER FOR INNER ELECTRODE OF MULTILAYER CERAMIC ELECTRONIC DEVICE AND FABRICATING METHOD THEREOF

(75) Inventors: Ju Hwan YANG, Suwon (KR); Jeong Min Cho, Seongnam (KR); Sung Kwon Wi, Seoul (KR); Ji Hwan Shin, Yongin (KR)

(73) Assignee: SAMSUNG ELECTRO-MECHANICS CO., LTD.

(21) Appl. No.: 13/111,270

(22) Filed: May 19, 2011

(30) Foreign Application Priority Data
Dec. 30, 2010 (KR) 10-2010-0139235

(51) Int. Cl. H01F 5/00; H01B 1/02; B05D 5/12

(52) U.S. Cl. 336/200; 427/123; 427/97.3; 252/512; 252/513; 252/514

(57) ABSTRACT

There are disclosed a nanocomposite powder for an inner electrode of a multilayer ceramic electronic device and a manufacturing method thereof. The nanocomposite powder for an inner electrode of a multilayer ceramic electronic device includes a first metal particle having electrical conductivity, and a second metal coating layer formed on a top surface or a bottom surface of the first metal particle and having a higher melting point than that of the first metal particle.

### CROSS-REFERENCE TO RELATED APPLICATIONS

This application claims the priority of Korean Patent Application No. 10-2010-0139235 filed on Dec. 30, 2010, in the Korean Intellectual Property Office, the disclosure of which is incorporated herein by reference.

### BACKGROUND OF THE INVENTION

1. Field of the Invention

The present invention relates to a nanocomposite powder for an inner electrode of a multilayer ceramic electronic device and a method of fabricating thereof, and, more particularly, to a nanocomposite powder for a multilayer ceramic electronic device, capable of preventing cracks in, or deformation of, the electronic device due to differences in sintering rates between a ceramic green sheet and an inner electrode and a method of fabricating the same.

2. Description of the Related Art

In general, an inner electrode in a chip part, such as a multilayer ceramic conductor (MLCC), a chip inductor, or the like, is manufactured by using an inner electrode paste which includes a conductive metal powder and other additives, for example, an organic vehicle such as an organic binder, an organic solvent, or the like, and then, printed on a ceramic green sheet through screen printing.

Conventionally, an MLCC has a plurality of dielectric layers between which inner electrodes are formed, as well as a pair of external electrodes connected to the inner electrodes. Here, each of the external electrodes is made of a conductive metal material such as silver, copper, or the like.

Recently, in order to accomplish an ultra-high capacity MLCC, a dielectric layer and an inner electrode have tended to be thin. In particular, in order to develop and mass-produce highly-multilayered products having at least 1,000 layers by using a dielectric layer having a thickness of 1 μM or less, a microfine ceramic powder or a microfine conductive powder may be employed.

With regard to an inner electrode paste using such a microfine conductive powder, attempts at matching the sintering shrinkage behaviors between the inner electrode and a dielectric layer by adding a ceramic powder having a high sintering initiation temperature to conductive metal particles such as nickel, palladium, or the like, have been carried out.

However, in a case in which an inner electrode paste for a high capacity MLCC is prepared by using a microfine powder, according to a conventional method, the inner electrode paste shows a low dispersibility and there may be difficulties in completely removing agglomerated powder. In addition, it is difficult to inhibit plastic shrinkage caused by sintering between metal particles during firing of an electrode after the electrode is formed. This is due to the fact that the metal particles and the ceramic powder are uniformly distributed, whereby the ceramic powder is inserted between the metal particles.

Accordingly, due to differences in sintering shrinkage behaviors between an inner electrode and a dielectric layer, cracks may occur at a boundary between the inner electrode and the dielectric layer and, when a thickness of the inner electrode is decreased, a defect in which the inner electrode is partially cut off because a shrinkage rate of the inner electrode is higher than that of the dielectric layer, may be entailed.

Therefore, in order to prevent deterioration in the connectivity of a thin film inner electrode and cracks caused by differences in sintering shrinkage behaviors between an inner electrode and a dielectric layer, various attempts at matching the shrinkage behaviors between the inner electrode and the dielectric layer have been conducted.

### SUMMARY OF THE INVENTION

An object of the present invention is to prevent cracks in or deformation of the electronic device caused by a different in sintering shrinkages between an inner electrode and a ceramic green sheet, by minimizing the sintering shrinkage of the inner electrode in a multilayer ceramic electronic device.

According to an exemplary embodiment of the present invention, there is provided a nanocomposite powder for an inner electrode of a multilayer ceramic electronic device, comprising: a first metal particle having electrical conductivity; and a second metal coating layer partially formed on a surface of the first metal particle.

The first metal particle may be made of nickel (Ni) or palladium (Pd).

The second metal coating layer may be made of any one selected from a group consisting of ferrum (Fe), palladium (Pd) and platinum (Pt).

The nanocomposite powder may include 1 to 10 parts by weight of the second metal coating layer relative to 90 to 99 parts by weight of the first metal particle.

The first metal particle having the second metal coating layer formed thereon may have a mean particle diameter of 100 nm or less.

The first metal particle having the second metal coating layer formed thereon has a lamellar shape.

The second metal coating layer may be formed on at least one of a top surface and a bottom surface of the first metal particle having the lamellar shape.

An inner electrode paste for a multilayer ceramic electronic device according to another exemplary embodiment of the present invention includes: a nanocomposite powder for an inner electrode of a multilayer ceramic electronic device, including a first metal particle and a second metal coating layer partially formed on a surface of the first metal particle and having a higher melting point than that of the first metal particle; and an organic vehicle including a binder, an organic solvent, or the like.

The inner electrode paste may include 30 to 80 parts by weight of the nanocomposite powder for an inner electrode and 20 to 70 parts by weight of the organic vehicle, in relation to 100 parts by weight of the inner electrode paste.

The first metal particle may be made of Ni or Pd.

The second metal coating layer may be made of any one selected from a group consisting of Fe, Pd and Pt.

The inner electrode paste may include 1 to 10 parts by weight of the second metal coating layer, relative to 90 to 99 parts by weight of the first metal particle.

The first metal particle having the second metal coating layer formed thereon may have a mean particle diameter of 100 nm or less.

The first metal particle having the second metal coating layer formed thereon may have a lamellar shape.

The second metal coating layer may be formed on at least one of a top surface and a bottom surface of the first metal particle having the lamellar shape.

A method of manufacturing a nanocomposite powder for an inner electrode of a multilayer ceramic electronic device according to another exemplary embodiment of the present invention, the method includes: mixing a plurality of first metal particles, a plurality of second metal particles having a higher melting point than that of the first metal particles, and a dispersion medium in a chamber; and rotating a shaft equipped with a plurality of rotors to rotate inside the chamber, thereby partially forming second metal coating layers on surfaces of the first metal particles by using the second metal particles.

The forming of the second metal coating layers on the first metal particles may be performed by mechanical alloying.

The first metal particles may be made of Ni or Pd

The second metal particles may be made of any one selected from a group consisting of Fe, Pd and Pt.

The nanocomposite powder may include 1 to 10 parts by weight of the second metal coating layers relative to 90 to 99 parts by weight of the first metal particles.

A multilayer ceramic electronic device according to another embodiment of the present invention, includes: a laminate body having a plurality of dielectric layers formed therein; first and second inner electrode patterns formed by printing an inner electrode paste for a multilayer ceramic electronic device on the plurality of dielectric layers and exposed to opposite end surfaces of the laminate body, wherein the inner electrode paste includes, a nanocomposite powder for an inner electrode of a multilayer ceramic electronic device that includes a first metal particle and a second metal coating layer partially formed on a surface of the first metal particle and having a higher melting point than that of the first metal particle; and an organic vehicle including a binder, an organic solvent, or the like; and first and second external electrodes formed on the opposite end surfaces of the laminate body, to which the first or second inner electrode patterns are exposed, and electrically connected to the first or second inner electrode patterns.

The nanocomposite powder may include 1 to 10 parts by weight of the second metal coating layer relative to 90 to 99 parts by weight of the first metal particle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a ceramic electronic device according to an exemplary embodiment of the present invention;

FIG. 2 is a cross-sectional view taken along line A-A′ shown in FIG. 1;

FIG. 3 is a schematic view illustrating an apparatus for manufacturing a nanocomposite powder for an inner electrode of a multilayer ceramic electronic device according to an exemplary embodiment of the present invention;

FIG. 4 is a flowchart illustrating a process of manufacturing a nanocomposite powder from a first metal particle and a second metal particle by mechanical alloying according to an exemplary embodiment of the present invention; and

FIG. 5 is graphs comparing sintering shrinkage rates between a ceramic green sheet and an inner electrode pattern according to an exemplary embodiment of the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

In addition, unless explicitly described to the contrary, the word “comprise” and variations such as “comprises” or “comprising,” will be understood to imply the inclusion of stated elements but not the exclusion of any other elements.

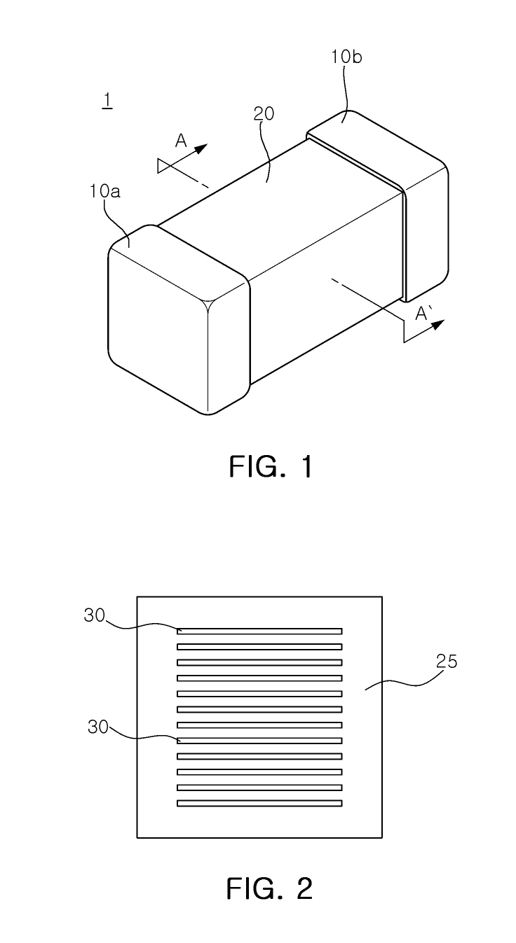

Hereinafter, with reference to FIGS. 1 through 5, a nanocomposite powder for an inner electrode of a multilayer ceramic electronic device and a fabrication method thereof according to an exemplary embodiment of the present invention, as well as an inner electrode paste including the nanocomposite powder according to the exemplary embodiment of the present invention and a multilayer ceramic electronic device manufactured by using the inner electrode paste, will be described in detail.

Referring to FIGS. 1 and 2, a multilayer ceramic electronic device 1 according to an exemplary embodiment of the present invention includes a laminate body 20, a first external electrode 10a and a second external electrode 10b.

Referring to FIG. 2 that shows a cross section in a direction of line A-A′ shown in FIG. 1, the laminate body 20 is formed by laminating a plurality of dielectric layers 25 and a plurality of inner electrodes 30 are laminated between these dielectric layers while having at least one dielectric layer disposed therebetween.

The plurality of dielectric layers 25 are formed by laminating ceramic green sheets, and each of the ceramic green sheets may be fabricated by mixing a barium titanate (BaTiO₃) based dielectric material and an organic binder, and then, treating the mixture by a doctor blade method, lip casting, or the like. In order to manufacture a high capacity MLCC, the dielectric layers 25 may be formed by laminating at least 1,000 ceramic green sheetshaving a thickness of 2.0 μM or less.

The first external electrode 10a and the second external electrode 10b are provided to connect the inner electrodes formed inside the laminate body to an external device, and may be made of a conductive metal material such as silver (Ag), copper (Cu), or the like.

Each of the inner electrodes 30 may contain a conductive material and be formed by adding an organic vehicle and an additive to the conductive material to prepare an inner electrode paste, and then, applying the inner electrode paste to a ceramic green sheet. In order to manufacture a high capacity MLCC, the inner electrodes needs to have a thickness of 2 μM or less. In this case, a conductive material having a particle size of 100 nm or less may be used.

After forming the laminate body by laminating the plurality of ceramic green sheets and the inner electrodes, the ceramic green sheets and the inner electrodes may be densified by sintering the formed laminate body. In such a case, a sintering shrinkage rate of the conductive material used for forming the inner electrode is higher than that of the ceramic green sheet. Therefore, the inner electrode may have a higher rate of shrinkage than that of the ceramic green sheet during sintering, thus causing defective connectivity of the inner electrode such as cut-off of the inner electrode, cracks, or the like.

However, when an inner electrode is formed by using the nanocomposite powder according to an exemplary embodiment of the present invention, a sintering shrinkage rate of the inner electrode may be reduced, compared to an inner electrode formed by using a conductive material according to the related art. As a result, matching of sintering features between the ceramic green sheet and the inner electrode during sintering the laminate body may be achieved.

Therefore, according to an exemplary embodiment of the present invention, a higher shrinkage rate of the inner electrode may be inhibited and as a result, cut-off of the inner electrode or occurrence of cracks thereof may be prevented. Consequently, the connectivity of an inner electrode in a high capacity multilayer ceramic electronic device may be secured, in turn ensuring chip reliability.

The following description will be given to explain a method of fabricating a nanocomposite powder according to an exemplary embodiment of the present invention, and the fabricated nanocomposite powder using the same.

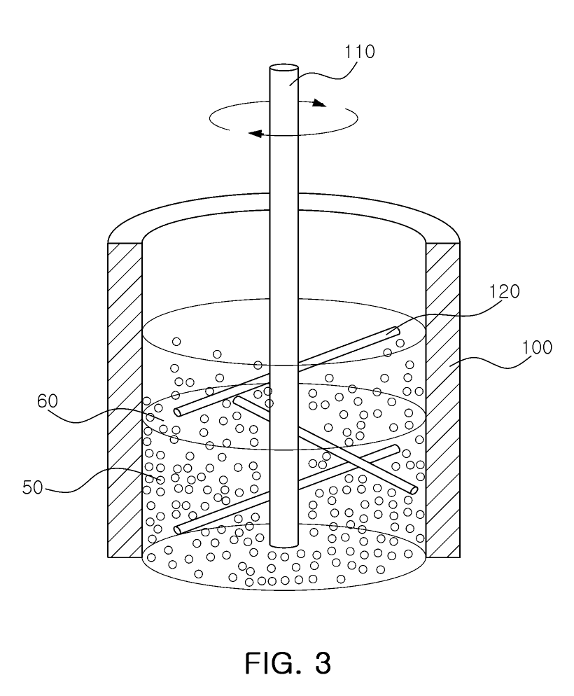

FIG. 3 shows an apparatus for manufacturing a nanocomposite powder according to an exemplary embodiment of the present invention.

The apparatus for manufacturing the nanocomposite powder may include a chamber 100, a shaft 110 formed to rotate in the chamber, and a plurality of rotors 120 connected to the shaft 110.

Raw materials 60 of the nanocomposite powder (herein after referred as to ‘nanocomposite powder materials) are introduced to the chamber 100 to manufacture the nanocomposite powder and a dispersion medium 50 for pressure welding and fracturing the nanocomposite powder materials 60 as well as the nanocomposite powder may be further added thereto.

The shaft 110 may be formed to rotate in the chamber 110. By rotating the shaft 110, the nanocomposite powder materials 60 and the dispersion medium 50 may be subjected to pressure welding and fracturing.

According to an exemplary embodiment of the present invention, a rotation speed and a rotation time of the shaft 110 may be controlled depending upon the nanocomposite powder materials 60 and the dispersion medium 50.

A rotor 120 is mounted on the shaft 110 is provided for agitating the contents in the chamber 100 according to rotation of the shaft 110, and at least one rotor 120 may be attached to the shaft 110.

The dispersion medium 50 may be added together with the nanocomposite material 60, may be made of a material having a high durability, and may apply energy to the nanocomposite material to support the pressure welding and fracturing of the nanocomposite material and the nano composite powder. A size of the dispersion medium 50 may be varied depending upon a size of the nanocomposite powder to be fabricated.

In order to fabricate the nanocomposite powder according to an exemplary embodiment of the present invention, a method of fabricating the nanocomposite powder may include: mixing a first metal particle, a second metal particle having a higher melting point than that of the first metal particle, and a dispersion medium in a chamber 100; and rotating a shaft 110 equipped with a plurality of rotors 120, which rotates in the chamber 100, to form a second metal coating layer on the first metal particles.

First, the nanocomposite material 60 and the dispersion medium 50 are mixed in the chamber.

The nanocomposite material 60 may include the first metal particle and the second metal particle.

Since the first metal particle has excellent electrical conductivity and is formed of a material having a low resistivity sufficient to endow low resistance to an inner electrode, in the case where the inner electrode is fabricated by using the first metal particle describe above. Without being particularly limited, the first metal particle may be made of Ni or Pd.

The second metal particle may be made of a material having a higher melting point than that of the first metal particle, and may form a coating layer on a top or bottom surface of the first metal particle to thereby reduce a sintering shrinkage rate of the nanocomposite powder. The second metal particle may be made of any one selected from the group consisting of Fe, Pd and Pt.

However, the material for the first metal particle is substantially different from the material for the second metal particle, and may have a melting point different from that of the material for the second metal particle. In particular, in the case where the first metal particle is made of Pd, the second metal particle is preferably made of Pt having a higher melting point than that of Pd.

According to an exemplary embodiment of the present invention, 90 to 99 parts by weight of the first metal particle and 1 to 10 parts by weight of the second metal particle, in relation to 100 parts by weight of the nanocomposite powder material, may be added.

When a content of the first metal particle is 90 or less parts by weight, the nanocomposite powder may have deteriorated electrical conductivity. On the other hand, when the content of the first metal particle exceeds 99 parts by weight, a sintering shrinkage rate of the nanocomposite powder may not be reduced. Therefore, the nanocomposite powder may include 90 to 99 parts by weight of the first metal particle in relation to 100 parts by weight of the nanocomposite powder.

Preferably, the nanocomposite powder may include 1 to 10 parts by weight of a second metal coating layer relative to 90 to 99 parts by weight of the first metal particle.

After mixing the nanocomposite material 60 and the dispersion medium 50 in the chamber 100, the second metal coating layer is formed on the first metal particle by rotating the shaft 110, to thereby prepare the nanocomposite powder.

According to an exemplary embodiment of the present invention, the fabrication of the nanocomposite powder by forming the second metal coating layer on the first metal particle may be performed by mechanical alloying.

The mechanical alloying is a high energy ball-milling process carried out in such a manner that elementary powder particles are repeatedly subjected to pressure welding, fracturing and re-welding between rapidly rotating dispersion medium s to thereby form a uniform and microfine alloy phase or fabricate a composite powder in a maximized mixing condition.

According to the mechanical alloying, a raw material powder is plastically deformed between the dispersion mediums and subjected to lamellar processing, to thereby allow pressure welding of two different elements, in turn forming an alloy powder having a lamellar structure. Here, fracturing and pressure welding between the elements are repeatedly conducted, resulting in a steady state in that the two elements are uniformly mixed. As a result of the mechanical alloying, a nano-crystalline material having a stable phase may be obtained.

According to an exemplary embodiment of the present invention, the uniform and microfine nanocomposite powder may be fabricated by introducing the first metal particle, the second metal particle and the dispersion medium into the chamber 100 and rotating the shaft at a very rapid speed, in order to conduct repetitive welding, fracturing and re-welding between the first metal particle and the second metal particle.

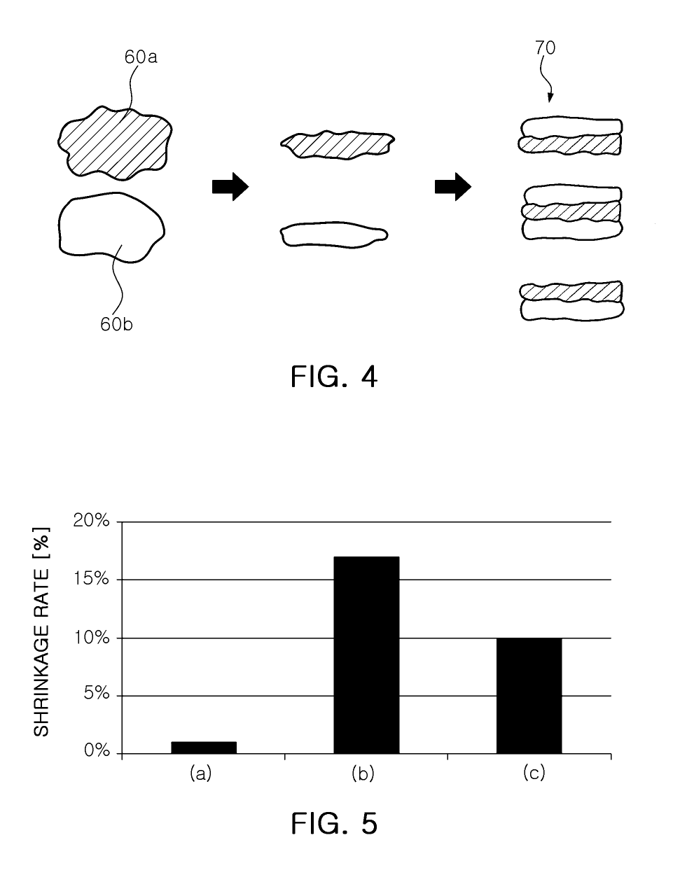

Referring to FIG. 4, a first metal particle 60a and a second metal particle 60b are plastically deformed between a dispersion mediums through mechanical alloying, and then, subjected to lamellar processing. By pressure welding of the first metal particles 60a and the second metal particles 60b, the alloy powder having a lamellar structure is formed. More particularly, the second metal coating layer is formed on a top or bottom surface, or both the top and bottom surfaces of the first metal particle 60a.

In this state, the pressure welding and the fracturing are repeatedly conducted to provide a steady state in which two different elements are uniformly mixed, thereby producing a nanocomposite powder 70 having a particle size of 100 nm or less in a stable phase.

In the case of the nanocomposite powder fabricated through the mechanical alloying described above, since the second metal coating layer having a higher melting point than that of the first metal particle may be formed on the first metal particle, the nanocomposite powder may have excellent electrical conductivity as in the first metal particle while exhibiting superior sintering shrinkage behavior similar to the second metal particle.

Meanwhile, since the nanocomposite powder has a lamellar shape, when this powder is used for manufacturing an inner electrode paste, a porosity of the paste may be reduced, compared to the case of using an inner electrode paste formed of a nanocomposite powder having spherical particles. Therefore, such an inner electrode paste may show excellent compactness on a green sheet. Because of the excellent compactness, a volumetric shrinkage rate during sintering, that is, a sintering shrinkage rate of the inner electrode may be decreased.

Accordingly, when an inner electrode is fabricated by using the nanocomposite powder an exemplary embodiment of the present invention, cracks in and deformation of the inner electrode caused by a different in sintering shrinkage rates between the inner electrode and the ceramic green sheet may be prevented.

Hereinafter, an inner electrode paste fabricated by using the nanocomposite powder according to an exemplary embodiment of the present invention will be described detail below.

The inner electrode paste used for manufacturing a multilayer ceramic electronic device may include a nanocomposite powder having electrical conductivity, an organic vehicle securing dispersibility, and an additive.

The nanocomposite powder is used for an inner electrode of the multilayer ceramic electronic device, in particular, for a MLCC. The nanocomposite powder is a material to endow electrical conductivity to the inner electrode and may be made of a metal having excellent electrical conductivity.

The nanocomposite powder may include a first metal particle having electrical conductivity, and a second metal coating layer formed on the top or bottom surface of the first metal particle and having a higher melting point than that of the first metal particle.

The second metal coating layer may be partially formed on the surface of the first metal particle and, in particular, when the first metal particle has a lamellar structure, the second metal coating layer may be formed on at least one of a top surface and a bottom surface of the first metal particle.

Referring to FIG. 4 a nanocomposite powder including a first metal particle and a second metal coating layer formed on the top surface of the first metal particle a nanocomposite powder including a first metal particle and second metal coating layers formed on the top and bottom surfaces of the first metal particle, and a nanocomposite powder including a first metal particle and a second metal coating layer formed on the bottom surface of the first metal particle are shown. The nanocomposite powder may have a variety of structures, as illustrated in the drawings.

The first metal particle may include Ni or Pd, while the second metal coating layer may be formed of anyone selected from the group consisting of Fe, Pd and Pt. The first metal particles may be included in an amount of 90 or more parts by weight in relation to 100 parts by weight of the nanocomposite powder. Thus, the nanocomposite powder may have excellent electrical conductivity and a low sintering shrinkage rate.

Since the first metal particle having the second metal coating layer formed thereon may have a mean particle diameter of 100 nm or less, the first metal particle may be suitable to a high capacity multilayer ceramic electronic device. Especially, the first metal particle may be suited to the fabrication of a ceramic green sheet and an inner electrode having a thickness of 2.0 μM or less, in turn manufacturing ultra-high capacity MLCCs.

The first metal particle having the second metal coating layer formed thereon may have a lamellar shape. Because of this, this first metal particle may give compactness to an inner electrode paste and reduce a sintering shrinkage rate thereof. Moreover, matching of sintering shrinkage features between an inner electrode and a ceramic green sheet may be attained.

The nanocomposite powder may be included in an amount of 30 to 80 parts by weight in relation to 100 parts by weight of the inner electrode paste. When the amount of the nanocomposite powder is less than 30 parts by weight, it is difficult to secure electrical conductivity. When the amount exceeds 80 parts by weight, dispersibility in the inner electrode paste is not ensured.

The organic vehicle may include a binder, an organic solvent, or the like, and may secure the viscosity and sintering properties of the inner electrode paste.

The binder is not particularly limited, however, may be an ethylcellulose resin and improve dissolubility of the nanocomposite powder and viscosity thereof.

The organic solvent is not particularly limited, however, may include terpineol, alpha-terpineol, dihydroterpineol, dihydroterpineol acetate, or the like, and improve an attack action to the ceramic green sheet.

According to an exemplary embodiment of the present invention, the organic vehicle may be added in an amount of 20 to 70 parts by weight in relation to 100 parts by weight of the inner electrode paste and the amount thereof may be controlled depending upon viscosity required according to printing methods of the inner electrode paste.

According to another exemplary embodiment of the present invention, a multilayer ceramic electronic device may be manufactured by using the electrode paste described above.

The multilayer ceramic electronic device may include: a laminate body having a plurality of dielectric layers formed therein; first and second inner electrode patterns formed by printing an inner electrode paste for a multilayer ceramic electronic device according to an exemplary embodiment of the present invention on the plurality of dielectric layers and exposed to opposite end surfaces of the laminate body; and first and second external electrodes formed on the opposite end surfaces, to which the first or second inner electrode patterns are exposed, and electrically connected to the first or second inner electrode patterns.

The inner electrode paste may include; a nanocomposite powder for an inner electrode of a multilayer ceramic electronic device that includes a first metal particle and a second metal coating layer partially formed on a surface of the first metal particle and having a higher melting point than that of the first metal particle; and an organic vehicle including a binder, an organic solvent, or the like. Particularly, the nanocomposite powder may include 1 to 10 parts by weight of the second metal coating layer relative to 90 to 99 parts by weight of the first metal particles.

Referring to FIG. 5, sintering shrinkage properties of an inner electrode and a dielectric layer in a multilayer ceramic electronic device manufactured according to an exemplary embodiment of the present invention may be shown

“(a)” is a graph showing a shrinkage rate of the ceramic green sheet, “(b)” is a graph showing a shrinkage rate of an inner electrode paste containing single metal powders, and “(c)” is a graph showing a shrinkage rate of an inner electrode pattern formed by using the nanocomposite powder.

In this regard, the shrinkage rate of the ceramic green sheet was less than 2%. However, in the case in which an inner electrode pattern is formed by using an inner electrode paste containing single metal powders, the shrinkage rate of the inner electrode pattern was more than 15%.

However, when an inner electrode pattern is formed by using the nanocomposite powder fabricated according to an exemplary embodiment of the present invention, the shrinkage rate of the inner electrode pattern is less than 10%.

Compared to using of single metal powders, when the nanocomposite powder according to the exemplary embodiment of the present invention was used, the shrinkage rate of the inner electrode pattern could be decreased by 5% or more. As a result, a difference in shrinkage rates between the ceramic green sheet and the inner electrode pattern may be reduced to the extent of 10% or less.

Consequently, according to an exemplary embodiment of the present invention, matching of sintering shrinkage behaviors between the inner electrode and the ceramic green sheet may be enhanced.

According to an exemplary embodiment of the present invention, a nanocomposite powder including a first metal particle and a second metal coating layer partially formed on the surface of the first metal particle and having a higher melting point than that of the first metal particle may be provided. In particular, since the nanocomposite powder has a lamellar structure, an inner electrode paste having excellent compactness may be fabricated.

Therefore, after printing and laminating the inner electrode paste on a ceramic green sheet, when the inner electrode paste is sintered together with the ceramic green sheet, a difference in sintering shrinkage rates between the inner electrode paste and the ceramic green sheet is not significantly increased. Accordingly, short circuits or cracks in an inner electrode may be prevented to thereby improve connectivity of the inner electrode. Moreover, chips having excellent reliability may be manufactured.

According to an exemplary embodiment of the present invention, a difference in shrinkage rates due to sintering between an inner electrode and a green sheet in a multilayer ceramic electronic device may be minimized, to thereby prevent cracks in or deformation of the multilayer ceramic electronic device caused by such a difference in sintering shrinkage rates between the inner electrode and the green sheet.

In addition, according to an exemplary embodiment of the present invention, transverse shrinkage of an inner electrode may be controlled by using the lamellar nanocomposite powder as an inner electrode material, thereby controlling a thickness of the inner electrode while improving connectivity of the inner electrode.

While the present invention has been shown and described in connection with the exemplary embodiments, it will be apparent to those skilled in the art that modifications and variations can be made without departing from the spirit and scope of the invention as defined by the appended claims.

What is claimed is:

1. A nanocomposite powder for an inner electrode of a multilayer ceramic electronic device, comprising:
a first metal particle having electrical conductivity; and
a second metal coating layer partially formed on a surface of the first metal particle.

2. The nanocomposite powder of claim 1, wherein the first metal particle is made of nickel (Ni) or palladium (Pd).

3. The nanocomposite powder of claim 1, wherein the second metal coating layer is made of any one selected from a group consisting of ferrum (Fe), palladium (Pd) and platinum (Pt).

4. The nanocomposite powder of claim 1, wherein an amount of the second metal coating layer ranges from 1 to 10 parts by weight, relative to 90 to 99 parts by weight of the first metal particle.

5. The nanocomposite powder of claim 1, wherein a mean particle diameter of the first metal particle having the second metal coating layer formed thereon is 100 nm or less.

6. The nanocomposite powder of claim 1, wherein the first metal particle having the second metal coating layer formed thereon has a lamellar shape.

7. The nanocomposite powder of claim 6, wherein the second metal coating layer is formed on at least one of a top surface and a bottom surface of the first metal particle having the lamellar shape.

8. An inner electrode paste for a multilayer ceramic electronic device, comprising:
a nanocomposite powder for an inner electrode of a multilayer ceramic electronic device, including a first metal particle and a second metal coating layer partially formed on a surface of the first metal particle and having a higher melting point than that of the first metal particle; and
an organic vehicle including a binder, an organic solvent, or the like.

9. The inner electrode paste of claim 8, wherein an amount of the nanocomposite powder for an inner electrode ranges from 30 to 80 parts by weight; and
an amount of the organic vehicle ranges from 20 to 70 parts by weight, in relation to 100 parts by weight of the inner electrode paste.

10. The inner electrode paste of claim 8, wherein the first metal particle is made of Ni or Pd.

11. The inner electrode paste of claim 8, wherein the second metal coating layer is made of any one selected from a group consisting of Fe, Pd and Pt.

12. The inner electrode paste of claim 8, wherein an amount of the second metal coating layer ranges from 1 to 10 parts by weight, relative to 90 to 99 parts by weight of the first metal particle.

13. The inner electrode paste of claim 8, wherein a mean particle diameter of the first metal particle having the second metal coating layer formed thereon is 100 nm or less.

14. The inner electrode paste of claim 8, wherein the first metal particle having the second metal coating layer formed thereon has a lamellar shape.

15. The inner electrode paste of claim 14, wherein the second metal coating layer is formed on at least one of a top surface and a bottom surface of the first metal particle having the lamellar shape.

16. A method of manufacturing a nanocomposite powder for an inner electrode of a multilayer ceramic electronic device, the method comprising:
mixing a plurality of first metal particles, a plurality of second metal particles having a higher melting point than that of the first metal particles, and a dispersion medium in a chamber; and
rotating a shaft equipped with a plurality of rotors to rotate inside the chamber, thereby partially forming second metal coating layers on surfaces of the first metal particles by using the second metal particles.

17. The method of claim 16, wherein the forming of the second metal coating layers on the first metal particles is performed by mechanical alloying.

18. The method of claim 16, wherein the first metal particles are made of Ni or Pd.

19. The method of claim 16, wherein the second metal particles are made of any one selected from a group consisting of Fe, Pd and Pt.

20. The method of claim 16, wherein an amount of the second metal coating layers range from 1 to 10 parts by weight relative to 90 to 99 parts by weight of the first metal particles.

21. A multilayer ceramic electronic device, comprising:
a laminate body having a plurality of dielectric layers formed therein;
first and second inner electrode patterns formed by printing an inner electrode paste for a multilayer ceramic electronic device on the plurality of dielectric layers and exposed to opposite end surfaces of the laminate body, wherein the inner electrode paste includes, a nanocomposite powder for an inner electrode of a multilayer ceramic electronic device that includes a first metal particle and a second metal coating layer partially formed on a surface of the first metal particle and having a higher melting point than that of the first metal particle; and an organic vehicle including a binder, an organic solvent, or the like; and
first and second external electrodes formed on the opposite end surfaces of the laminate body, to which the first or second inner electrode patterns are exposed, and electrically connected to the first or second inner electrode patterns.

22. The multilayer ceramic electronic device of claim 21, wherein an amount of the second metal coating layer ranges from 1 to 10 parts by weight relative to 90 to 99 parts by weight of the first metal particle.
